(19) United States
(12) Patent Application Publication
(10) Pub. No.: US 2005/0025327 A1
(43) Pub. Date: Feb. 3, 2005

(54) Spa audio system

(76) Inventors: Stephen S. Macey, Oceanside, CA (US); Robin A. French, Fallbrook, CA (US)

Correspondence Address: Albin H. Gess;SNELL & WILMER L.L.P., Suite 1200, 1920 Main Street, Irvine, CA, 92614-7230, US

(21) Appl. No.: 10/935,953

(22) Filed: Sep. 8, 2004

Related U.S. Application Data
(63) Continuation-in-part of application No. 10/364,080, filed on Feb. 11, 2003.
Application No. 10/364,080 is a continuation of application No. 09/516,132, filed on Mar. 1, 2000, now Pat. No. 6,556,684.

(51) Int. Cl. H04R 5/02; H04R 1/02; A47K 3/00

(52) U.S. Cl. 381/333; 381/388; 381/301

(57) ABSTRACT

A portable spa including an audio system designed to use the spa shell as the sound generating device. Transducer devices are bonded to the spa shell so as to couple the sound vibration energy to the shell.

### CROSS-REFERENCE TO RELATED APPLICATIONS

This application is a continuation-in-part of an application for Spa Audio System, U.S. Ser. No. 10/364,080, filed Feb. 11, 2003, which is a continuation of an application for Spa Audio System, Ser. No. 09/516,132, filed Mar. 1, 2000, now U.S. Pat. No. 6,556,684.

### BACKGROUND OF THE INVENTION

1. Field of the Invention

The subject invention relates generally to spas and more particularly to an audio system utilizing a spa shell as the sound-generating device.

2. Description of Related Art

Existing spa audio systems use traditional speakers wherein the audio drivers are exposed to the harsh spa environment and/or require protection or the use of esoteric materials to prevent premature failure. Existing spa audio systems also suffer from the limited space available to mount speakers. The resultant smaller speakers are incapable of producing full range audio (50 Hz-17 kHz).

### SUMMARY OF THE INVENTION

According to the invention, a spa shell is employed as an audio driver with audio transducers mounted inside the skirt of the spa directed to the underside of the spa shell. The inventor has found that the spa shell provides both sufficient rigidity for high frequency reproduction and a sufficiently large surface area to achieve low frequency reproduction. A transducer mounting block is attached to the underside of spa shell by an adhesive or other suitable means. A preferred attachment mechanism is a pre-formed metal mounting plate embedded in the plastic underside layer of the spa shell to which an audio transducer is fastened.

### BRIEF DESCRIPTION OF THE DRAWINGS

The exact nature of this invention as well as the objects and advantages will be readily apparent upon consideration of the following specification describing the preferred embodiments of the invention, as illustrated in the accompanying drawings in which like reference numerals designate like parts throughout the figures thereof and wherein:

FIG. 1 is a schematic cross-sectional diagram illustrating a spa audio system according to a preferred embodiment;

FIG. 2 illustrates an enclosure apparatus for attaching transducers to the spa shell;

FIG. 3 is a schematic diagram of an alternate embodiment employing an RF transmitting device.

FIG. 4 is a top elevation of a transducer mounting plate;

FIG. 5 is a cross-section of the mounting plate of FIG. 4 along line 5-5.

FIG. 6 is a top elevation of an alternate transducer mounting plate;

FIG. 7 is a cross-section of the mounting plate of FIG. 6, along line 7-7;

FIG. 8 is a perspective of transducer mounting plate attached to the underside of a spa shell; and

FIG. 9 is a cross-section of a portion of a spa sheet showing a transducer mounting plate embedded in the underside of a spa shell.

### DETAILED DESCRIPTION OF THE PREFERRED EMBODIMENTS

FIG. 1 illustrates a spa audio system according to a preferred embodiment. According to this embodiment, audio transducer devices 11 are bonded to a spa shell 13. The transducer devices 11 couple the sound vibration energy so that sound can be heard when using the spa. Two transducer devices 11 are preferably provided for stereo effect but one device, or more than two devices, may also be used. The transducer devices 11 may be driven by a conventional integrated audio amplifier 15, providing, e.g., 100-300 watts per channel.

The spa shell 13 is rigid enough to support the weight of water and bathers but is sufficiently compliant to reproduce full range audio. A typical spa shell 13 is formed of a thermoset plastic, thermoplastic or acrylic top sheet having a thickness of 0.100-0.300 inches. As is well known in the spa industry, additional layers of material (not shown) are provided to the underside of the shell 13 to provide structural support. Of course, other materials and dimensions providing the functional prerequisites for water/bather support and audio transmission may be employed.

Rigid engagement of each transducer device 11 to the spa shell 13 is required. One installation method preferably prevents spa insulation material such as structural foam applied to the underside of sheet 13 from contaminating the transducer/shell coupling. This is achieved by constructing the transducer device 11 as a formed enclosure that surrounds a transducer element and installing it to the spa shell 13 before the insulation material is applied to the underside of the shell 13. A suitable audio transducer element is Model TST 329 as available from Clark Synthesis, Inc., 8122 S. Park Lane, Littleton, Colo. 80120.

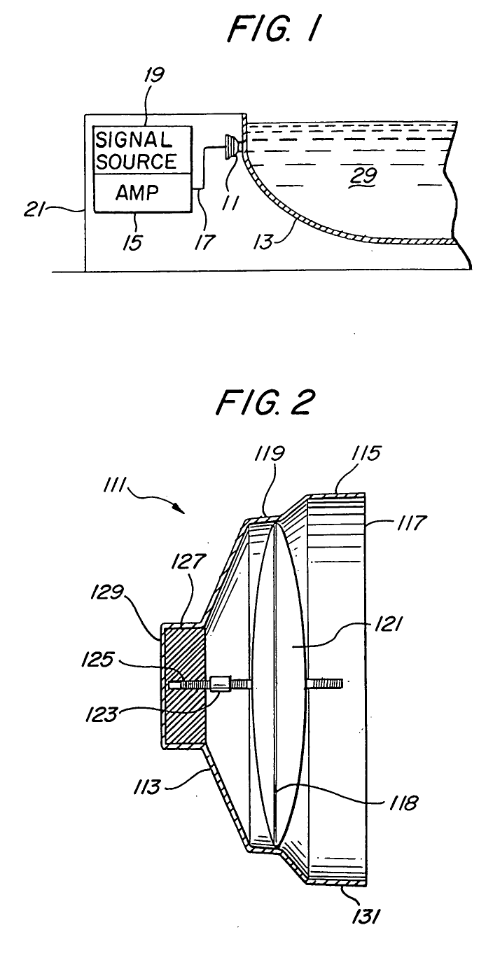

An illustrative formed enclosure 111 is shown in FIG. 2. This enclosure 111 includes a thermoformed molded plastic housing 113, which may be fabricated, for example, from ⅛″ ABS plastic. The housing 113 includes an outer cylindrical shell portion 115, which provides a circular rim or edge 117, which is open.

Adjacent the open rim 117 of the enclosure 111, a somewhat smaller concentric cylindrical portion 119 is provided, which is of a diameter selected to support the outer rim 118 of the transducer element 121. A nut 123 is threaded onto a threaded projection of the transducer 121 and receives a threaded end of a stud 125. The stud 125 threads into a cylindrical block, plug or puck 127 formed of plastic or metal at a closed end 129 of the housing 113, thereby attaching and further supporting the transducer 121 within the housing 113.

Attachment of the housing 113 and the cylindrical block 127 to the spa shell 13 is preferably provided by using a thermoplastic adhesive for gluing the end 129 of the housing 113 to the shell 13 (FIG. 1). Or, or structural foam could also be used to attach the housing to the shell 13. The puck 127 is then glued to the inside of the housing 113 at the closed end 129 with any suitable adhesive. The block 127 and the housing 113 are embedded in the structural foam underside of the shell 13 and are held fast to the shell 13 by the structural foam and the adhesive.

Additionally, support to the lower end 131 of the housing 113 may be provided, for example, via a brace attached to the spa frame structure at the lower end 131 of the housing in order to relieve any shear stress created by hanging the housing/transducer assembly off the side of the spa shell 13. A hatch or door in the spa skirt 21 (FIG. 1) may also be provided to access the speaker enclosures 111 through the open ended rim 117 of housing 113.

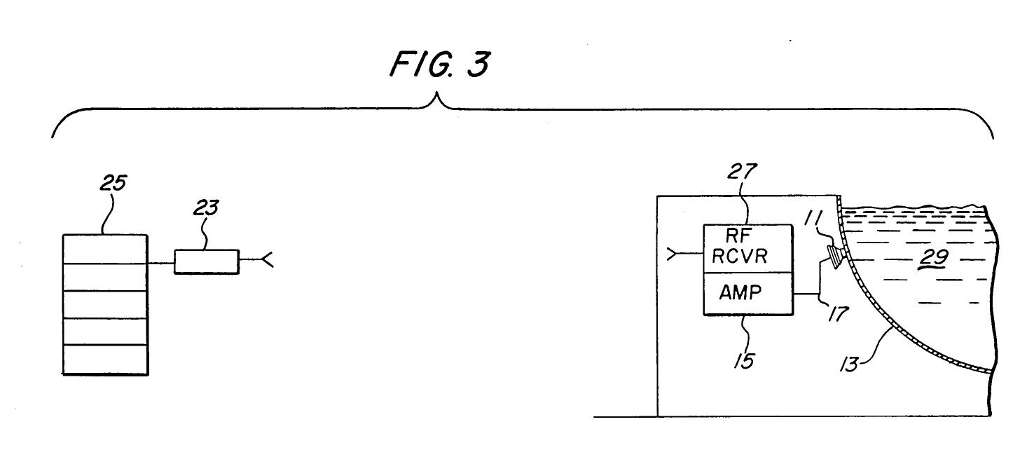

The output signal of the amplifier 15 may be coupled to the transducers via conventional speaker wire 17. In such case, the amplifier 15 and audio components 19 supplying it, such as preamplifiers and/or CD players, may be located in a compartment within the spa skirt 21 or at a remote site. Alternatively, as shown in FIG. 3, a remote transmitting device 23 (e.g., RF) may be used to enable use of a homeowner's home audio system 25 as the music signal source. Such remote transmitting devices are commercially available. For example, the 900 MHz or 2.4 GHz wireless receiver/transmitters provided by X-10 USA, Closter, N.J. 07624, may be used. In such case, a receiver 27 located at the spa provides the home audio signal to the amplifier 15, which then drives the transducers 11.

In operation, the audio can be heard under water 29 as well as above the water 29. Listeners outside the spa can also hear the audio signal, but the experience is muted compared to that of the tub occupant.

The means of attaching an acoustic driver to the spa shell is important, in order to cause the spa shell to function as a speaker cone driven by the audio transducer attached to it, with a frequency range comparable to an average speaker system. The attachment means is important also to the extent that it must perform in a harsh outside, and perhaps wet, environment, without breaking down. If the interface connection between the spa shell and the audio transducer breaks down, by coming loose, for example, the function of the entire system fails.

Besides using appropriate compatible adhesives to attach mounting blocks to the underside of the spa shell, for mounting audio transducers, it has been found that the use of mounting plates bonded to the underside of a spa shell is also very effective to couple the audio transducer to the spa shell itself.

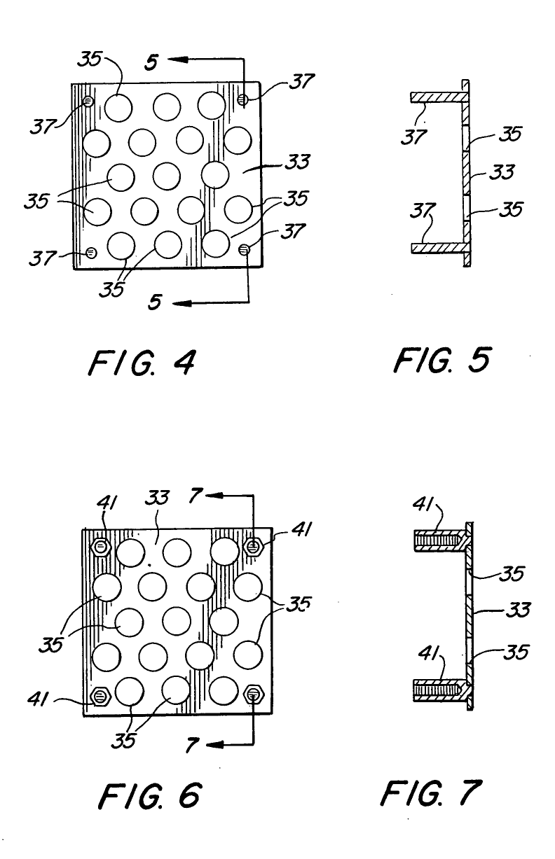

A mounting plate 33, according to the present invention, is shown in FIGS. 4 through 7. The mounted plate 33 may be made of plastic metal, and is preferably made out of a material of sufficient strength to withstand considerable flexure forces over a long period of time without fatigue. The mounting plate, when made of metal, is preferably about 4 inches in length and 4 inches in width and about 0.13 inches thick. The mounting plate 33 has a plurality of holes 35 scattered throughout the plate in a random pattern, each hole being about 0.83 inches in diameter.

The mounting plate 33 carries a plurality of mounting studs 37/41 which are either externally or internally threaded. Mounting studs 37 are externally threaded. Mounting studs 41 are internally threaded. The studs 37/41 are attached to the mounting plate 33 by threading into mounting plate 33 or by some other convenient fixing means, such as welding, or by nuts (not shown).

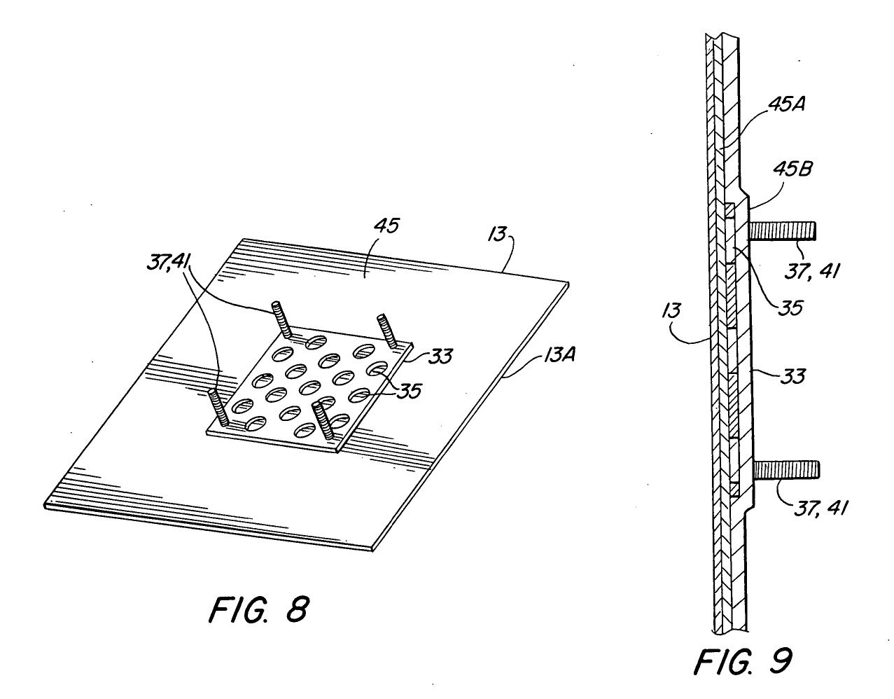

Referring now to FIG. 8, mounting plate 33 with its audio transducer mounting studs 37/41 is shown attached to the underside of the spa shell 13. Spa shell 13 has a top side 13A formed of an acrylic plastic, for example, and a bottom side 45 having one or more layers of fiberglass. The audio transducer mounting plate 33 is held fast to the underside 45 of spa shell 13 by being embedded in the fiberglass underside 45 in a manner more specifically shown in FIG. 9.

FIG. 9 is a cross-sectional illustration of a portion of the spa shell invention showing how the audio transducer mounting plate 33 is embedded in the underside layers 45A and 45B of the spa shell 13. The top side of spa shell 13 may be an acrylic synthetic material or similar plastic, as mentioned earlier, which is supported on its underside by one or more layers of fiberglass or other similar material for providing support and strength to the spa shell 13. Besides fiberglass, the underside layers 45A and 45B may also be any suitable thermoplastic material.

The audio transducer mounting plate 33 with its transducer mounting studs 37/41 thereon is embedded in the fiberglass layer 45A while it is still soft so that the fiberglass material of layer 45A holds the mounting plate 33 in place, while a second subsequent layer 45B of fiberglass material is laid over the first layer 45A and mounting plate 33. During this layering process, the holes 35 in mounting plate 33 are filled by the fiberglass material, effectively forming bonding plugs through each one of the holes 35 in the mounting plate, causing the plate 33 to be held at each one of the different locations along its surface. Each one of these bonding plugs acts as rivets, holding the plate at a separate location on its surface. This redundancy of fastening a plate to the underside of spa shell 13 insures longevity for the attachment and the necessary rigidity required to transfer vibration energy from the audio transducer to the shell itself.

As may be appreciated, the preferred embodiments permit the audio transducer devices to be enclosed within the spa, providing improved aesthetics by eliminating exposed speaker locations. Enclosing the transducer devices within the spa also protects them from water and reduces the risk of water exposure to electrical signals. Moreover, the bonding of the audio transducer to the spa shelf according to the present invention turns the spa shell into a speaker with a surprising frequency range.

From the above description, those skilled in the art will appreciate that various adaptations and modifications of the just-described preferred embodiments can be configured without departing from the scope and spirit of the invention. Therefore, it is to be understood that within the scope of the appended claims, the invention may be practiced other than as specifically described herein.

1. A spa audio system comprising:
a spa shell formed of a plastic top sheet and plastic support material applied to the underside of the plastic top sheet;
a mounting plate embedded in the underside plastic support material; and
an audio transducer affixed to the mounting plate;
wherein the audio transducer is adapted to accept signals from a sound source and transform the signals into vibrations.

2. The spa audio system of claim 1 wherein the plastic top sheet is an acrylic plastic.

3. The spa audio system of claim 1 wherein the underside support material is fiberglass.

4. The spa audio system of claim 1 wherein the mounting plate has a plurality of holes, the plastic underside material forming attachment points at each one of the holes in the mounting plate.

5. The spa audio system of claim 4 wherein the plastic top sheet is an acrylic plastic.

6. The spa audio system of claim 4 wherein the underside support material is fiberglass.

7. The spa audio system of claim 4 further comprising mounting studs attached to the mounting plate for affixing the audio transducer to the mounting plate.

8. The spa audio system of claim 7 wherein the mounting studs are externally threaded.

9. The spa audio system of claim 7 wherein the mounting studs are internally threaded.

10. The spa audio system of claim 8 or 9 wherein the mounting studs are welded to the mounting plate.

11. The spa audio system of claim 8 or 9 wherein the mounting studs are threaded into the mounting plate.

12. The spa audio system of claim 4 wherein the mounting plate is made of plastic.

13. The spa audio system of claim 12 further comprising mounting studs attached to the mounting plate for affixing the audio transducer to the mounting plate.

14. The spa audio system of claim 13 wherein mounting studs are made of plastic.

15. The spa audio system of claim 14 wherein the mounting studs are externally threaded.

16. The spa audio system of claim 15 wherein the mounting studs are internally threaded.

17. The spa audio system of claim 4 wherein the mounting plate is made of metal.

18. The spa audio system of claim 17 wherein the plastic top sheet is an acrylic plastic.

19. The spa audio system of claim 17 wherein the underside support material is fiberglass.
